(19) United States
(12) Patent Application Publication
(10) Pub. No.: US 2012/0105191 A1
(43) Pub. Date: May 3, 2012

(54) EXPLOSION-ROOF AND FLAMEPROOF EJECTION TYPE SAFETY SURGE-ABSORBING MODULE

(76) Inventor: Robert WANG, Luch (TW)

(21) Appl. No.: 13/346,948

(22) Filed: Jan. 10, 2012

Related U.S. Application Data
(63) Continuation-in-part of application No. 12/490,683, filed on Jun. 24, 2009.

(51) Int. Cl. H01H 37/76

(52) U.S. Cl. 337/414

(57) ABSTRACT

An explosion-proof and flameproof ejection type safety surge-absorbing module includes a protective member and a surge-absorbing unit. The protective member comprises a base and an upper lid coupled with the base. The base has two corresponding partitions extending upwards. The surge-absorbing unit includes a body, two connecting leads, and a resilient metallic plate. The body has two sides each defining an electrode surface. The electrode surface is connected with one of the connecting leads. The resilient metallic plate has a first end welded to the electrode surface with a contact member and a second end curved and striding across an outer side of one of the partitions to penetrate through the bottom of the base. In case the body of the surge-absorbing unit is overheated due to high temperature caused by a surge, the contact component will be melted allowing the resilient metallic plate to eject away from the electrode.

This applications is a continuation-in-part of, and claims a priority to U.S. Ser. No. 12/490,683 filed on Jun. 24,2009.

### BACKGROUND OF THE INVENTION

1. Field of the Invention

This invention relates to an explosion-proof and flameproof ejection type safety surge-absorbing module.

2. Description of the Prior Art

Generally, in order to prevent a surge i.e. either a pulse voltage or a pulse current, suddenly occurred in daily life from damaging electrical equipment, a surge absorber is normally provided in the circuit of an electrical appliance. In a conventional circuit, it is further added a thermal fuse so that the surge absorber will cause the circuit to become open circuit for the protection of the equipment or surge absorber itself when detecting a surge or a high temperature.

Although the thermal fuse is capable of making the circuit with a surge absorber to become open circuit, however, the circuit may not become open circuit in a short period of time causing the surge absorber being over heated. Thus, the surge absorber could cause explosion or start a fire to damage the equipment and form a fire accident. In view of this actual situation, it is necessary to provide an improved surge absorber.

### SUMMARY OF THE INVENTION

It is the main object of the present invention to provide an explosion-proof and flameproof ejection type safety surge-absorbing module which can cause the electric circuit to become open circuit without over heated.

Another object of the present invention is to provide an explosion-proof and flameproof ejection type safety surge-absorbing module which can cause the electric circuit to become open circuit without the generation of flame or even explosion.

The main feature of the present invention is to provide a resilient metallic plate normally welded to the electrode through a contact component which shall be melted while the electrode is over heated. The resilient metallic plate will eject away from the electrode when the contact component is melted.

Accordingly, the explosion-proof and flameproof ejection type safety surge-absorbing module according to the present invention comprises a protective member which comprises a base and an upper lid coupled thereto. The base has two partitions formed thereon and extended upwardly to form a chamber for the installation of a surge-absorbing unit. The surge-absorbing module further comprises a surge absorbing unit which comprises a body with two opposite sides forming two corresponding electrodes, at least two connecting leads each connected to one of the electrodes. A resilient metallic plate having a first end welded to the electrode through a contact component and a second end passing through out of the base of the protective member forming a third lead.

The leads of the surge-absorbing unit are connected respectively to power source and circuit load to form a normal circuitry to supply power to electric equipments. In case the body of the surge-absorbing unit is overheated due to high temperature caused by a surge, the contact component will be melted allowing the resilient metallic plate to eject away from the electrode. Therefore the electric circuit will become open circuited without damaging the surge-absorbing module. In case the body being exploded due to a very high temperature caused by the surge, the protective member will function to prevent any further accident.

### BRIEF DESCRIPTION OF THE DRAWINGS

The object, advantages and features of the explosion-proof and flameproof ejection type safety surge-absorbing module of the present invention can be more apparent from the below detail description of the preferred embodiments with reference to the accompanying drawings, wherein:

FIG. 1 is a perspective view of an explosion-proof and flameproof ejection type safety surge-absorbing module according to the present invention;

FIG. 2 is a perspective exploded view of an explosion-proof and flameproof ejection type safety surge-absorbing module according to the present invention;

FIG. 3 is a cross-sectional view of an explosion-proof and flameproof ejection type safety surge-absorbing module according to the present invention;

FIG. 4 is a cross-sectional view of an explosion-proof and flameproof ejection type safety surge-absorbing module illustrating the connection of the resilient metallic plate with power source and circuit load;

FIG. 5 is a cross-sectional view of an explosion-proof and flameproof ejection type safety surge-absorbing module illustrating the resilient metallic plate being ejected away from the electrode;

FIG. 6 is a cross-sectional view of a second embodiment of the explosion-proof and flameproof ejection type safety surge-absorbing module having two resilient metallic plates according to the present invention;

FIG. 7 is a cross-sectional view of the second embodiment of the explosion-proof and flameproof ejection type safety surge-absorbing module illustrating the resilient metallic plates connection to the electrodes, power source and circuit load; and

FIG. 8 is a cross-sectional view of the second embodiment of the explosion-proof and flameproof ejection type safety surge-absorbing module showing the resilient metallic plates being ejected from the corresponding electrodes.

### DETAILED DESCRIPTION OF THE PREFERRED EMBODIMENTS

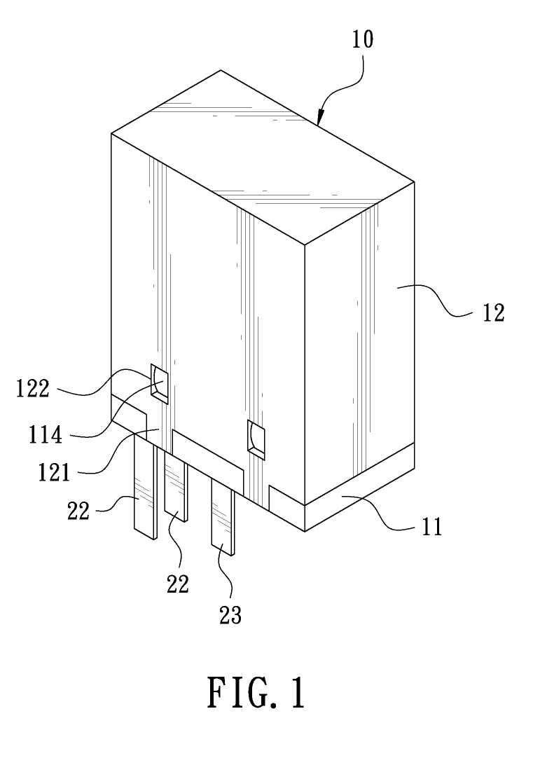

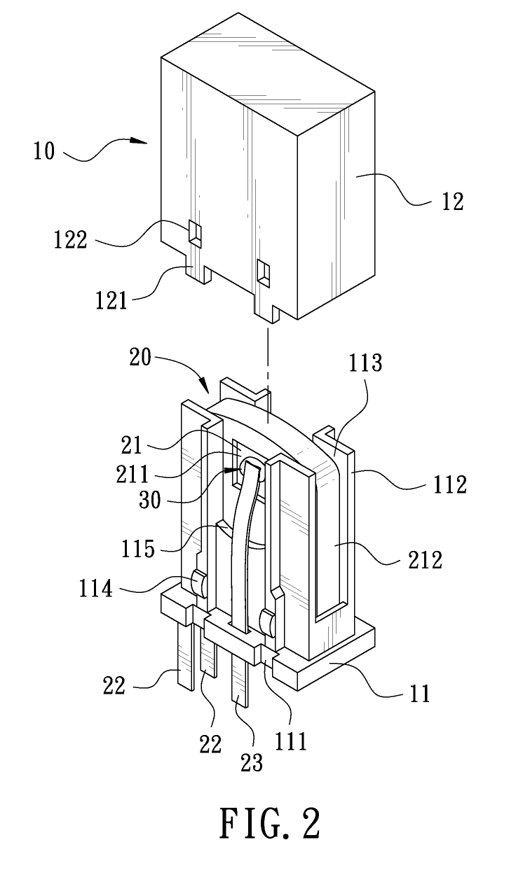

Referring to FIG. 1 with reference to FIG. 2 which is a perspective and exploded view of the explosion-proof and flameproof ejection type safety surge-absorbing module according to the present, the surge absorbing module comprises a protective member 10 and a surge-absorbing unit 20.

The protective member 10 comprises a base 11 and an upper lid 12 coupled to said base 11. The base 11 has a plurality of notches 111 formed at a circumferential portion thereof and spaced apart from each other. Two partitions 112 are formed on the base 11 and extend upwardly to form a chamber 113 surrounded by the partitions 112. A plurality of protrusions 114 are formed on the wall of said partitions 112 and a recess 115 being at the middle portion of each partition 112.

The upper lid 12 has a plurality of tenons 121 fitting with the notchs 111 of the base 11 so that the upper lid 12 can be coupled to the base 11. The upper lid 12 also has positioning holes 122 formed thereon to match with said protrusions 114 on the partitions 112 to form a tight connection between base 11 and the upper lid 12.

The surge-absorbing unit 20 comprises a body 21, two conducting leads 22 and a resilient metallic plate 23. The body 21 is made of Zinc Oxide and stored in the chamber 113. The body 21 has two opposite sides forming two electrodes 211 which are connected by said leads 22. The leads 22 and the resilient metallic plate 23 are extending out of the bottom of the base 11 of the protective member 10. The body 21 is wrapped with epoxy resin 212 which serves as an insulation between the electrodes 211. The upper portions of the conducting leads 22 are also wrapped in the epoxy resin 212. The resilient metallic plate 23 is welded, with its first end, to the electrode 211 through a contact component 30. This component 30 can be a solder or the like but with not a high melting point. The contact component 30 had better be inserted in said recess 115 of said partitions 112. The resilient metallic plate 23 is naturally bent due to its resilience with its another end extending along the out side of the partitions 112 and penetrating through the bottom of the base 11.

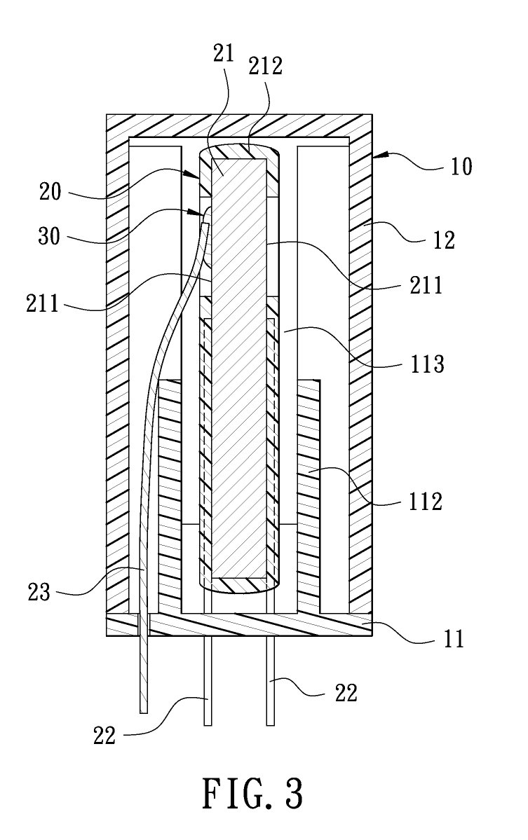

Referring to FIG. 3 which shows a cross-sectional view of an explosion-proof and flameproof ejection type safety surge-absorbing module according to the present invention, the assembled surge-absorbing module has its resilient metallic plate 23 with its one end welded on the electrode 211 through the contact component 30.

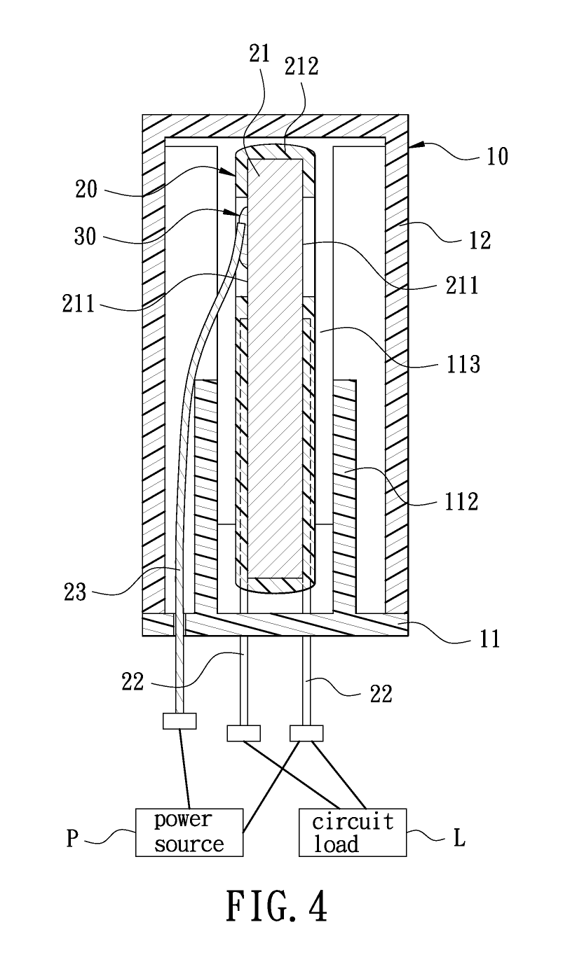

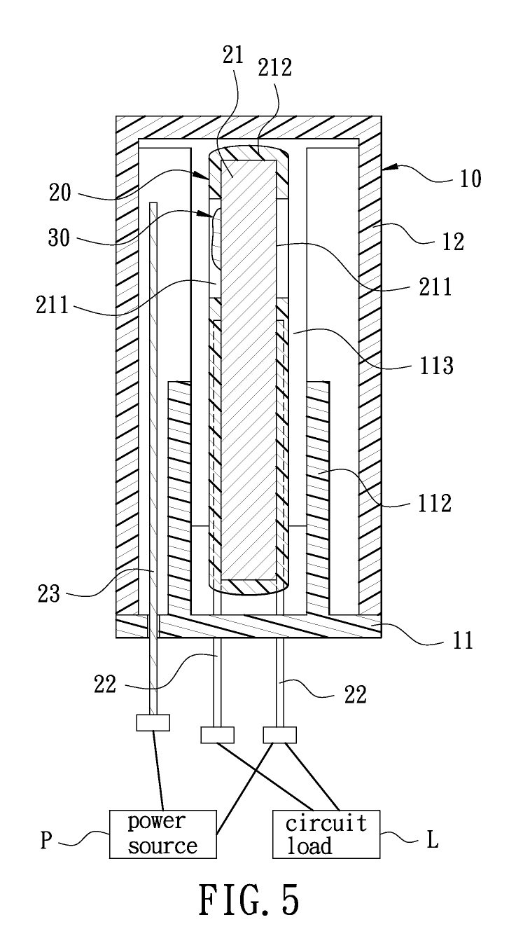

Referring to both FIGS. 4 and 5, they are cross-sectional views of the surge-absorbing module with illustration of circuit connection to Power Source P and Circuit Load L. If due to any reason such as thunder lighting, a surge is generated at Power Supply P. It will be conducted through the resilient metallic plate 23 to be absorbed by the surge-absorbing unit 20. In the meantime, the electrodes 211 will be heated by the electric energy brought by the surge. Once the over-heated situation is achieved, the contact component 30 will be melted and the resilient metallic plate 23 will be ejected away from the electrode 211 and in turn forming a open circuit of the electric circuit. In FIG. 5, it is seen that the resilient metallic plate 23 has been ejected to a open circuit position. This will prevent the circuit load L from damage

It is to be noted that the contact component 30 shall be made of material with relatively low melting point so that the resilient metallic plate 23 can be disconnected with the electrodes 211 in a short time period. Also, one can easily understand, because of one of the partitions 112 is situated between the body 21 of the surge-absorbing unit 20 and the resilient metallic plate 23, that an electric arc caused by the surge can be isolated. In a further extreme case, if the resilient metallic plate 23 is not ejected to become open circuited quick enough and body 21 of the surge-absorbing unit 20 becomes exploded, the upper lid 12 of the protective member 10 entirely covers the body 21 to prevent from any further accident.

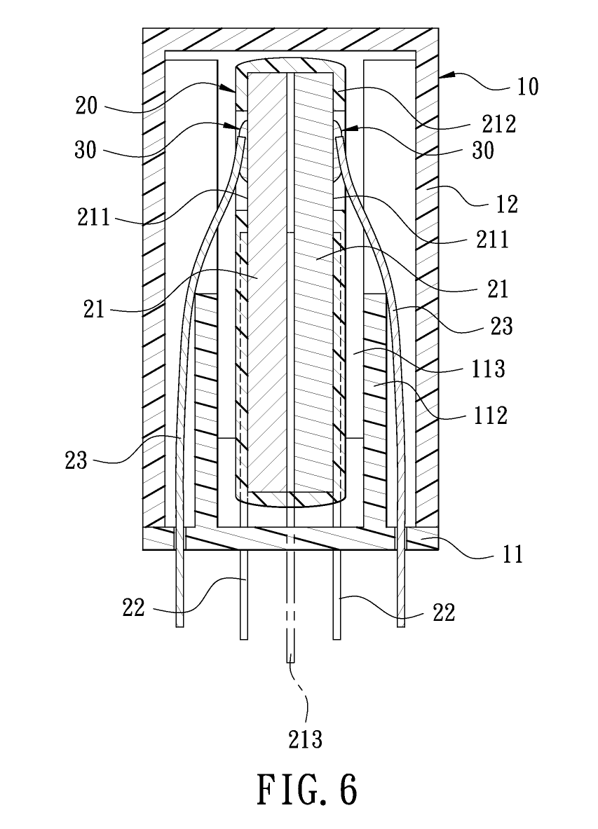

Referring to FIG. 6, it is a cross-sectional view of a second embodiment of the explosion-proof and flameproof ejection type safety surge-absorbing module having two resilient metallic plates according to the present invention. This module is substantially the same in structure as the first embodiment except the surge-absorbing unit 20 consisting of two bodies 21 and two resilient metallic plates 23. There are two electric leads 22 similar to structure of the first embodiment of the module shown in FIGS. 1 to 3. Referring to FIG. 6, the two bodies 21 are stacked and form a common out lead 213 between the said two bodies 21. The two perspective sides of the bodies 21 form electrodes 211 respectively and the electric leads 22 are connected thereto. Again, each of the resilient metallic plates has its one end connected to the respective electrodes 211 through contact component 30. And the other end of the resilient metallic plate penetrates outwardly through the base 11 of the protective member 10.

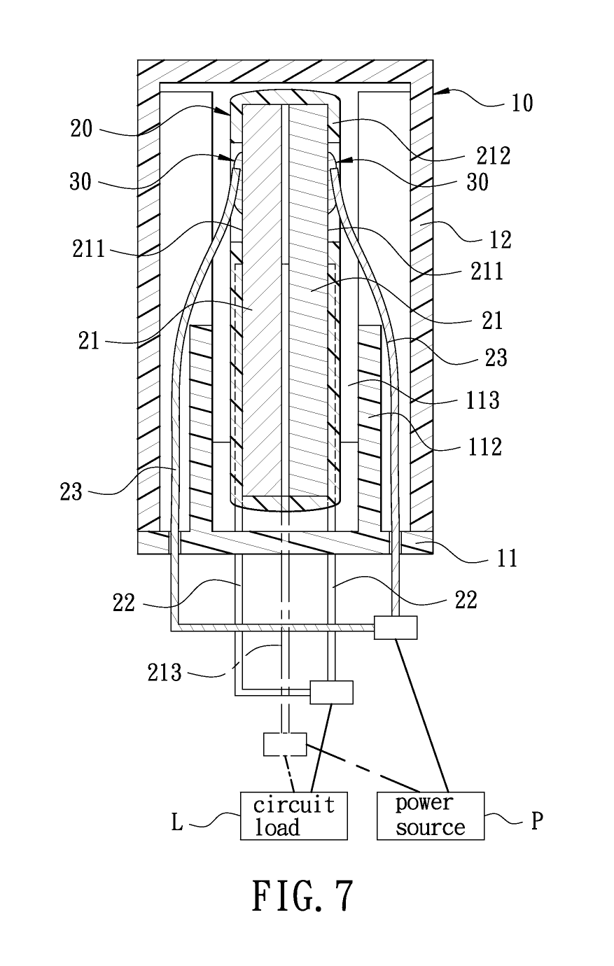

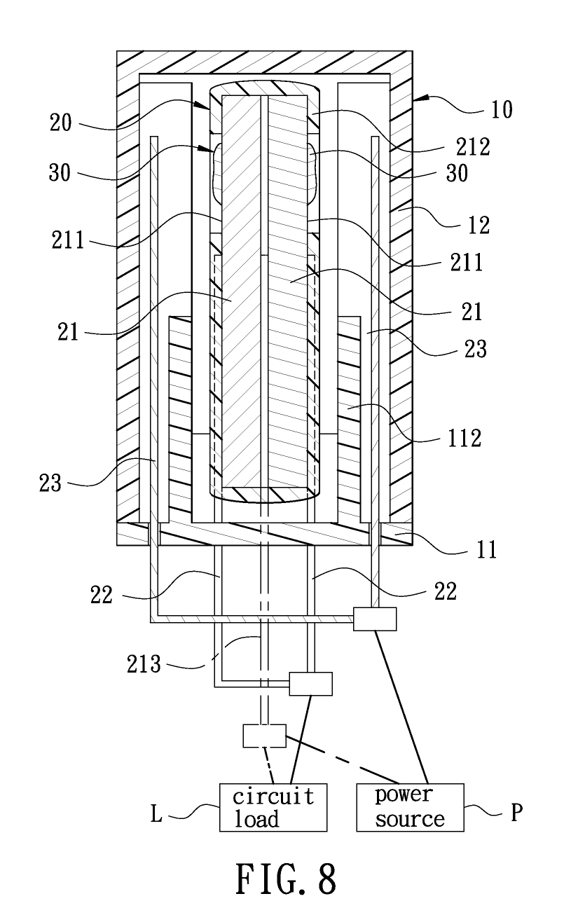

Referring to FIGS. 7 and 8, they show the circuit connection with Power Source P and Circuit Load L of the second embodiment of the explosion-proof and flameproof ejection type safety surge-absorbing module. The Power Source P is connected in parallel with the resilient metallic plates 23 and the common electric lead 213. The Circuit Load L is connecting to the electric leads 22 and the common lead 213. It is readily known, with this embodiment of surge-absorbing module, when heat generated due to surge on the bodies 21 and the temperature exceeds the melting point of the contact component 30, the resilient metallic plates 23 will ejected due to its resilience and cause the circuit to become open circuit.

Although particular embodiments of the present invention have been described in detail for purposes of illustration, various modifications and enhancements may be made without departing from the spirit and scope of the appended Claims in accordance with the present invention.

What is claimed is:

1. An explosion-proof and flameproof ejection type safety surge-absorbing module, comprising:
a protective member which comprises a base and an upper lid coupled with said base, said base having two corresponding partitions formed thereon and extending upwardly to form a chamber, said partitions having one of its side forming into an electrode, said base further comprises a plurality of notches at a circumferential portion thereof and said upper lid having tenons fitting with said notches for said upper lid to be coupled to said base of the protective member; and
a surge-absorbing unit having a body, at least two electric leads and a resilient metallic plate, said body being installed in said chamber of said protective member, said electric leads being connected to said electrodes on said partitions, said resilient metallic plate, with one first end thereof being connected to one of said electrodes through a connect component having a substantially low melting point and a second end thereof penetrating out of said base of said protective member.

2. An explosion-proof and flameproof ejection type safety surge-absorbing module according to claim 1, wherein said body of said surge-absorbing unit is wrapped with epoxy resin and upper portions of said conducting leads are wrapped in the epoxy resin.

3. An explosion-proof and flameproof ejection type safety surge-absorbing module according to claim 1 wherein each of said partitions is formed with a recess at a middle portion thereof.

4. An explosion-proof and flameproof ejection type safety surge-absorbing according to claim 3 wherein said connect component is disposed in said recess and said first end of said resilient metallic plate is connected to said connect component in said recess.

5. An explosion-proof and flameproof ejection type safety surge-absorbing according to claim 1 said surge absorbing unit comprises two bodies, two connecting leads and two resilient metallic plates; said two bodies being stacked with a common lead formed between said two bodies, said two contacting leads being connected to said electrodes on said partitions and said two resilient plates with their respective one first end connected to said electrodes.

6. An explosion-proof and flameproof ejection type safety surge-absorbing module according to claim 1 wherein said contact component is a solder.
